(19) United States
(12) Patent Application Publication
(10) Pub. No.: US 2026/0192810 A1
(43) Pub. Date: Jul. 9, 2026

(54) LEARNING OF AUTONOMOUS DRIVING MODELS FROM AIR PER DRIVING SCENARIOS

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 19/208,633

(22) Filed: May 15, 2025

Related U.S. Application Data
(63) Continuation-in-part of application No. 19/091,942, filed on Mar. 27, 2025.
(60) Provisional application No. 63/741,926, filed on Jan. 5, 2025.

(51) Int. Cl. B60W 50/00; B60W 60/00; G05B 13/02

(52) U.S. Cl. CPC B60W 50/0098; B60W 60/001; G05B 13/0265; B60W 2554/4042; B60W 2554/4049; B60W 2556/10; B60W 2556/65

(57) ABSTRACT

The present disclosure provides a method of learning from air of scenario-based artificial intelligence models for autonomous driving, the method includes obtaining air based data of a region containing multiple ground vehicles and road objects; analyzing, in a machine learning process, the air based data from respective points of view of the multiple ground vehicles per driving scenario of a range of real-world driving scenarios; and creating, based on the analyzing, corresponding training sets for artificial intelligence models used in autonomous driving of the multiple ground vehicles, wherein the corresponding training sets are created per driving scenario and include road object information pertaining to the respective point of view of the multiple ground vehicles in the driving scenario.

### CROSS-REFERENCE TO RELATED APPLICATIONS

This application claims the benefit of U.S. patent application Ser. No. 19/091,942, filed Mar. 27, 2025 and U.S. Provisional Patent Application 63/741,926, filed Jan. 5, 2025, which is incorporated herein by reference in its entirety.

### FIELD

The present disclosure relates to artificial intelligence systems for autonomous vehicles, and more particularly to methods and systems for training autonomous driving models using aerial imagery data.

### BACKGROUND

Autonomous driving technology has emerged as a rapidly advancing field in the automotive industry. This technology relies heavily on machine learning models to interpret and respond to complex driving environments. These models are designed to process vast amounts of data collected from various sensors and cameras equipped on vehicles. Artificial intelligence (AI) models are the type of machine learning models that is most commonly used in autonomous driving applications.

The development of autonomous driving systems involves training machine learning models using large datasets. These datasets typically include images and sensor readings captured by vehicles during real-world driving scenarios. The quality and diversity of this training data play a crucial role in the performance and reliability of the resulting autonomous driving systems.

Vehicle-mounted cameras and sensors collect a wide range of visual and non-visual data as the vehicle navigates through different environments. This data may include images of road conditions, traffic signs, other vehicles, pedestrians, and various obstacles. Additionally, sensors capture information about the vehicle's speed, acceleration, and position.

The collected image and sensor data serve as input for training machine learning models. These models are designed to recognize and classify objects, interpret road conditions, and make decisions about vehicle control. The training process involves exposing the models to numerous examples of driving scenarios, allowing them to learn patterns and develop the ability to generalize to new situations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure provides a method of learning from air for autonomous driving. The method involves obtaining an aerial image containing aerial data of a region containing multiple ground vehicles and road objects. The method further includes analyzing, in a machine learning process, the aerial data from respective points of view of the multiple ground vehicles. Based on this analysis, the method produces respective ground vehicle views, each from a respective point of view of a different ground vehicle and including road object information pertaining to the respective point of view of each different ground vehicle. These ground vehicle views are to be applied in training an artificial intelligence (AI) model to be used in driving an autonomous vehicle.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a schematic view of an AI training system for autonomous vehicles and its environment, according to aspects of the present disclosure.

FIG. 2 depicts an aerial view of a road environment with multiple ground vehicles and objects, according to an embodiment.

FIG. 3 illustrates the road environment of FIG. 2 with a different vehicle's field of view, according to aspects of the present disclosure.

FIG. 4 depicts the road environment of FIG. 2 showing another vehicle's field of view, according to an embodiment.

FIG. 5 is a flowchart illustrating a method for learning from air for autonomous driving, according to aspects of the present disclosure.

FIG. 6 is a flowchart illustrating a method for learning from air for autonomous driving, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Autonomous vehicles rely on sophisticated artificial intelligence (AI) models to navigate complex road environments safely and efficiently. These AI models require vast amounts of high-quality training data to learn and improve their decision-making capabilities. Traditionally, gathering such training data has involved equipping numerous vehicles with sensors and cameras to capture real-world driving scenarios over extended periods.

However, this conventional approach to data collection presents significant challenges. The process of outfitting multiple ground vehicles with specialized equipment and deploying them to capture diverse driving situations across various locations and conditions is both time-consuming and resource-intensive. Furthermore, the data collected from ground-level perspectives may be limited in scope, potentially missing important contextual information about the broader traffic environment.

As the demand for more advanced and reliable autonomous driving systems continues to grow, there is an increasing need for methods that can generate large volumes of diverse and high-quality training data more efficiently. Addressing this challenge requires innovative approaches that can accelerate the data collection process while maintaining or even enhancing the richness and relevance of the captured information for training AI models used in autonomous vehicles.

The present disclosure provides a solution to the challenges of gathering diverse and high-quality training data for autonomous vehicle AI models by leveraging aerial imagery. This approach enables the efficient generation of multiple simulated ground-level perspectives from a single aerial view, significantly accelerating the data collection process.

In some cases, the method begins with obtaining an aerial image that captures a region containing multiple ground vehicles and various road objects. This aerial image may be acquired using aerial vehicles, such as drones, unmanned aerial vehicles, satellites, or other elevated imaging platforms, providing a comprehensive view of the traffic environment.

The aerial data contained within the captured aerial image may then be analyzed using AI or other machine learning techniques. This analysis may be performed from the respective points of view of multiple ground vehicles present in the aerial image. By applying advanced computer vision and image processing algorithms, the system may interpret the aerial data to understand the spatial relationships, orientations, and positions of vehicles and road objects within the scene, as well as analyzing kinematic relationships and trajectories among ground vehicles and other road objects. In the context of the present description and in the claims, the term “road objects” refers to any and all objects (other than ground vehicles) that may have an impact on driving decisions of vehicles in the vicinity of such objects.

Based on this analysis, the present methods may produce respective ground vehicle views, each corresponding to the point of view of a different ground vehicle in the scene. These simulated ground vehicle views may include road object information pertaining to what would be visible from the perspective of each individual ground vehicle. In some cases, the ground vehicle views may incorporate details such as occlusions, relative distances, and orientations of nearby vehicles and road objects.

This approach may allow for the generation of numerous ground-level perspectives from a single aerial image, potentially creating a rich dataset that captures diverse driving scenarios and interactions between multiple ground vehicles. The resulting ground vehicle views may be used to support autonomous driving applications, providing valuable training data for AI models without the need for extensive deployment of sensor-equipped vehicles.

By transforming aerial imagery into multiple simulated ground-level perspectives, this method may offer a more efficient and scalable approach to generating training data for autonomous driving systems. The ability to produce diverse viewpoints from a single aerial image may enhance the breadth and depth of scenarios available for AI model training, potentially leading to more robust and adaptable autonomous driving capabilities.

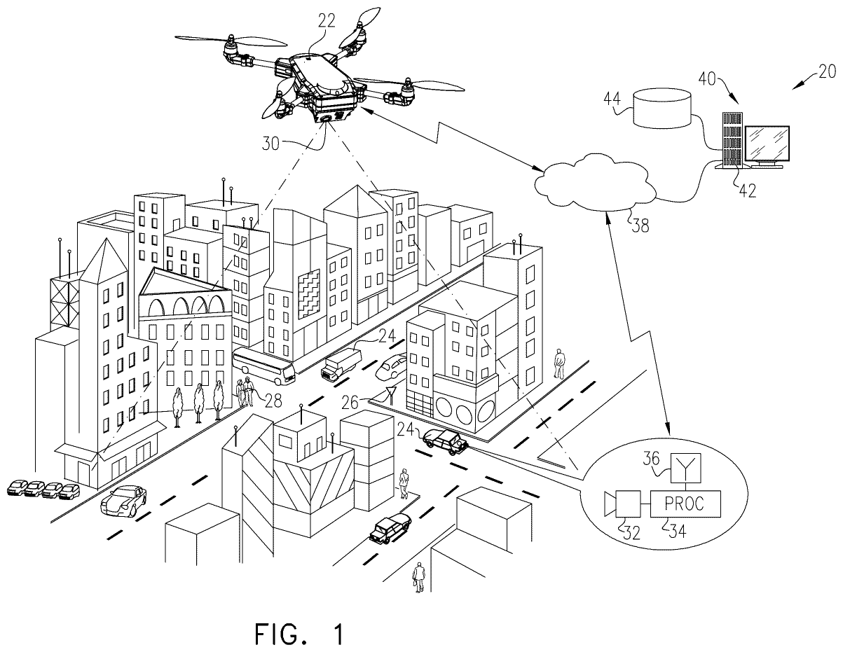

FIG. 1 illustrates a schematic view of an AI training system 20 for autonomous vehicles. The AI training system 20 may include an aerial vehicle 22 equipped with an aerial camera 30 positioned to capture aerial imagery of a region containing roads, ground vehicles 24, and road objects, such as a road sign 26 and pedestrians 28.

In some cases, the aerial camera 30 may capture images in various wavelengths, including visual light, monochromatic, radar, infrared, thermal, or near infrared. The aerial vehicle 22 may be a satellite, drone, manned airplane, unmanned aerial vehicle, aerial military equipment, or aerial commercial equipment. The aerial images captured by the aerial camera 30 may cover an area ranging from 50 to 10,000,000 square meters and may be captured from heights ranging from tens of meters to thousands of kilometers.

The aerial vehicle 22 may transmit images captured by the aerial camera 30 via a communication network 38, such as a wireless communication network, to a server 40. The server 40 may contain a processor 42 and memory 44 for processing and storing the aerial and ground vehicle image data.

One or more ground vehicles 24 within the field of view of the aerial camera 30 may be equipped with a vehicle camera 32 to capture images from a ground perspective. (Images captured by individual ground vehicles 24 are referred to as “ego images”.) A processing unit 34 in the ground vehicle 24 may transmit these images through a communication interface 36 via the communication network 38 to the server 40.

In some cases, the ground vehicle 24 may include an Advanced Driver Assistance System (ADAS) control unit for controlling ADAS operations. The ground vehicle 24 may also include an Autonomous Driving (AD) control unit for controlling autonomous driving. Additionally, the ground vehicle 24 may include a vehicle computer, integrated with or separate from the processing unit 34, for controlling engine, transmission, and other vehicle systems.

The processor 42 of the server 40 may process the aerial imagery to generate training data that simulates ground-level perspectives of multiple ground vehicles based on the aerial view. The memory 44 may store the aerial images containing aerial data, as well as processed image data and trained AI models. The processor 42 processes the aerial data and the ground data from the vehicle cameras 32, in a machine learning process, to generate these multiple ground vehicle perspectives from a single aerial view.

In some cases, the processor 42 may perform sensor fusion of aerial information from different types of aerial sensors. The AI training system 20 may use different types of machine learning, including supervised, unsupervised, semi-supervised, and reinforcement learning to train the AI models for autonomous driving applications.

In some cases, the processor 42 may construct a three-dimensional (3D) model of a region based on the aerial imagery, and may then project the respective points of view of the ground vehicles 24 onto this model to generate the simulated ground-level perspectives. For this purpose, for example, the processor 42 may apply topographical data with respect to the region, for example data provided by detailed topographical maps. Additionally or alternatively, the server 40 may receive at least two aerial images captured (simultaneously or sequentially) from two or more different aerial locations, and the processor 42 may apply a stereoscopic transformation to the aerial images to generate the 3D model.

The system may enable transformation of aerial imagery captured by the aerial camera 30 into multiple simulated ground-level perspectives corresponding to different vehicle positions and orientations on the road, which may be used to train AI models for autonomous driving applications. Techniques that can be used in performing this sort of transformation are described further hereinbelow. Additionally or alternatively, the simulated ground vehicle views may be used in validating operations of an AI driving model that is trained using, at least in part, sensed data captured from a ground vehicle sensor for autonomous driving.

According to an embodiment, the transformation includes transforming content and/or context and/or any metadata related to the aerial image to content and/or context and/or any metadata related to each one of the ground-level perspectives. For example, the transformation may include converting an object list associated with the aerial imagery to object list associated with different vehicles. It should be noted that the conversion should take into account occlusions and the like. For example, a ground vehicle that cannot see a certain object nearby can receive information about that object (even marked-currently at least partially occluded). According to an embodiment, the content and/or context and/or any metadata provides a kinematic representation of objects related to the ground vehicles. According to an embodiment, the transformation of imagery and/or of the content and/or context and/or any metadata may be based on comparing signatures of the aerial imagery to signatures of ground vehicle perspective—for example by using a cross view module as illustrated in U.S. patent application Ser. No. 18/527,701, which is incorporated herein by reference. According to an embodiment, the conversion may be done based on a mapping (a rule-based mapping or an artificial intelligence-based mapping) that is generated and/or trained by feeding aerial images and ground view images of the same content. According to an embodiment, the conversion is made using simulation. According to an embodiment the simulation uses at least one step of the method illustrated in U.S. Pat. No. 11,392,738, which describes a method for generating simulation scenarios for autonomous vehicles using aerial images and ground vehicle data and which is incorporated herein by reference. According to an embodiment, the conversion uses at least one step of the method of U.S. Patent Application Publication No. 2025/0029209, which describes a method for lane detection using neural networks to convert between aerial images and ground vehicle-acquired images and which is incorporated herein by reference.

According to an embodiment, the processor is configured to execute any of the steps illustrated in U.S. Patent Application Publication No. 2024/0083431, which is incorporated herein by reference and discloses a system for training and testing machine learning processes for autonomous vehicles using virtual fields based on simulations of vehicle behaviors.

According to an embodiment, the conversion uses at least one step of the method described in U.S. Patent Application Publication No. 2024/0208534, which presents a method for performing driving-related operations based on aerial images and sensed environmental information such as radar data and is incorporated herein by reference.

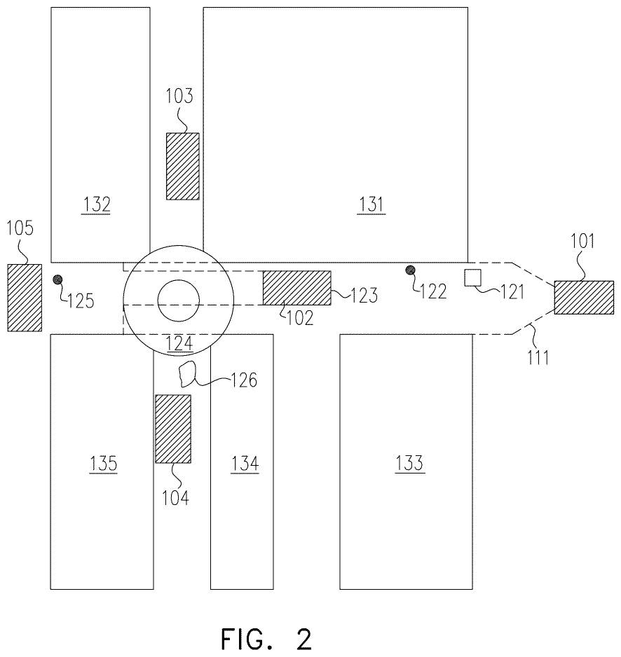

FIG. 2 illustrates a road environment with multiple ground vehicles, buildings, and other road objects, as captured in an aerial view, for example from the aerial vehicle 22 (FIG. 1). The AI training system 20 may analyze this aerial view to generate ground-level perspectives for multiple ground vehicles. This figure and the figures that follow illustrate how the server 40 is able to extract simulated ground vehicle views from the points of view of multiple different vehicles from the same aerial image.

In the pictured example, the road environment includes a first vehicle 101, a second vehicle 102, a third vehicle 103, a fourth vehicle 104, and a fifth vehicle 105 positioned at various locations within the environment. The server 40 may analyze the aerial data to determine the positions, orientations, and movements of these vehicles.

The environment may contain several buildings, including a first building 131, a second building 132, a third building 133, a fourth building 134, and a fifth building 135 arranged around the roadway area. These buildings may serve as reference points and potential obstacles in the analysis of vehicle behavior and road conditions.

In this example, a traffic circle 124 is positioned centrally in the diagram, with various road objects distributed around it. These objects may include a traffic signal 121, a first pedestrian 122, a first road obstacle 123, a second pedestrian 125, and a second road obstacle 126. The processing unit 34 may identify and track these objects to generate comprehensive behavioral information for each ground vehicle 24.

A first field of view 111 represents a viewing area or field of vision extending from the first vehicle 101. This field view 111 is indicated by dashed lines showing the observable area from that vehicle's perspective. The processor 42 may use this information to create an object list view from the perspective of the first vehicle 101.

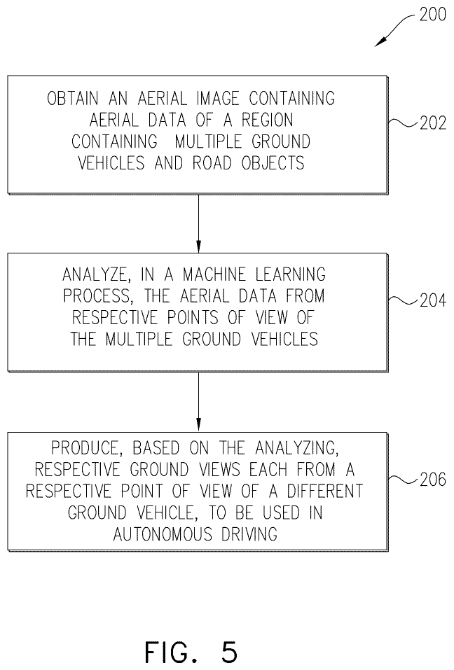

In some cases, the processor 42 may incorporate learned ground noise distributions to objects in the object list views. This may involve adjusting the perceived positions or characteristics of objects based on typical noise patterns observed in ground-level sensors, enhancing the realism of the simulated ground vehicle views. These ground noise distributions are typical of the views seen from vehicle cameras and include, for example, shifts in the vertical and lateral positions of other vehicles and ground objects. The machine learning process that is applied in generating the simulated ground vehicle views may remove the noise distributions that are characteristic of the aerial images while introducing noise based on typical ground noise distributions. Further details of the techniques that can be applied in handling noise distributions are described below with reference to FIG. 5.

The processor 42 may generate road user behavioral information based on the aerial information. For example, the processor may analyze the movements and interactions of the vehicles and pedestrians within the traffic circle 124, determining factors such as speed, acceleration, and steering patterns. Thus, the processor 42 extracts not only positional information regarding the vehicles and road objects, but also the relative kinematics and trajectories, for use in training and autonomous driving.

In some cases, the processor 42 may compare behaviors of different vehicles facing the same situation to provide comparison results. For instance, the processor may analyze how the first vehicle 101 and the second vehicle 102 approach and navigate the traffic circle 124, identifying any differences in their behavior or decision-making.

By creating object list views from ground vehicle perspectives, the AI training system 20 may generate a rich dataset for training autonomous driving models. These views may include information about visible objects, their relative positions, potential occlusions, kinematics, and trajectories, providing a detailed simulation of what each vehicle's sensors might detect in real-world driving scenarios.

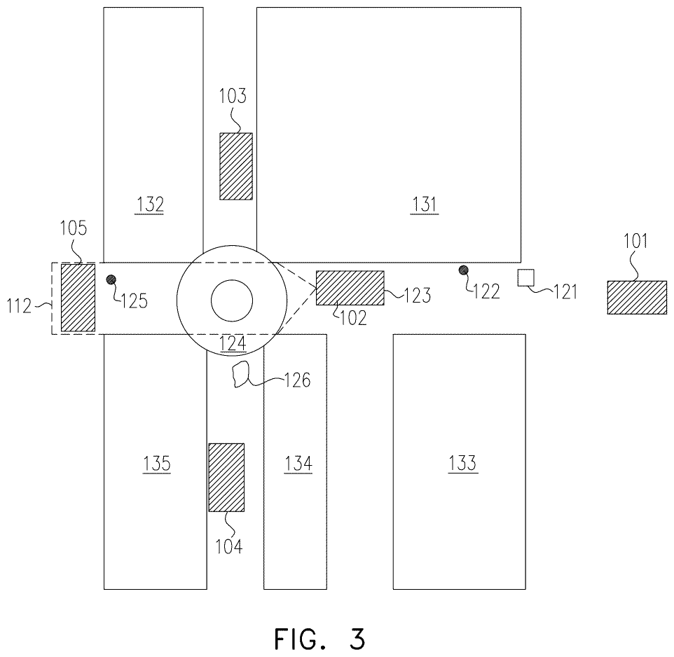

FIG. 3 illustrates the same road environment layout as FIG. 2, showing the same vehicles, buildings, and road objects as viewed from an aerial perspective. In this figure, a second field of view 112 represents a viewing area extending from the second vehicle 102, indicated by dashed lines showing the observable area from that vehicle's perspective.

The second field of view 112 differs significantly from the first field of view 111 shown in FIG. 2. While the first field of view 111 was oriented towards the traffic circle 124, the second field of view 112 is directed away from the traffic circle 124, providing a distinct perspective of the road environment.

In some cases, the processor 42 may analyze the aerial data to determine which objects are visible from the second vehicle 102's perspective. The processor 42 may ascertain that certain objects visible in the aerial view may be occluded from the ground-level perspective of the second vehicle 102.

For example, the processor 42 may determine that the first pedestrian 122 and the traffic signal 121, which are clearly visible in the aerial view, may be occluded by the first building 131 from the perspective of the second vehicle 102. As a result, these objects may be excluded from the ground vehicle view generated for the second vehicle 102.

Similarly, the processor 42 may ascertain that the third vehicle 103 and the fourth vehicle 104 are likely occluded by the second building 132 and the fifth building 135, respectively, from the perspective of the second vehicle 102. These vehicles may therefore be excluded from the ground vehicle view generated for the second vehicle 102.

In contrast, the processor 42 may determine that the fifth vehicle 105, the second pedestrian 125, and the second road obstacle 126 are within the second field of view 112 and not occluded by any buildings or other objects. These elements may be included in the ground vehicle view generated for the second vehicle 102.

By carefully analyzing the aerial data and considering occlusions from the ground-level perspective, the AI training system 20 may generate more accurate and realistic ground vehicle views for each vehicle. This approach may enhance the quality of the training data used for autonomous driving models, potentially improving their ability to handle real-world driving scenarios with partially obscured views.

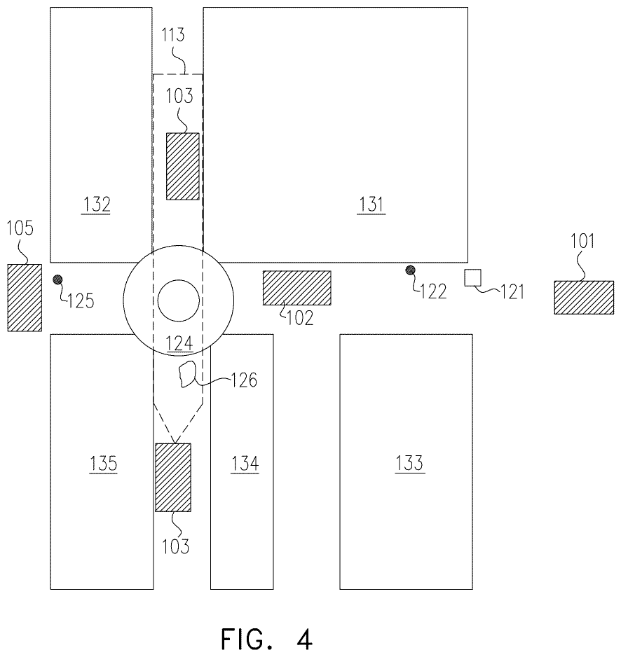

FIG. 4 illustrates the same road environment layout as FIGS. 2 and 3, showing multiple ground vehicles, buildings, and road objects as viewed from an aerial perspective. In this figure, a third field of view 113 represents a viewing area extending from the third vehicle 103, indicated by dashed lines showing the observable area from that vehicle's perspective.

The third field of view 113 differs significantly from the first field of view 111 and the second field of view 112 shown in previous figures. While the first field of view 111 was oriented towards the traffic circle 124 and the second field of view 112 was directed away from the traffic circle 124, the third field of view 113 provides a unique perspective of the road environment from the vantage point of the third vehicle 103.

In some cases, the processor 42 may analyze the aerial data to determine which objects are visible from the perspective of the third vehicle 103. The processor 42 may ascertain that certain objects visible in the aerial view may be occluded from the ground-level perspective of the third vehicle 103.

For example, the processor 42 may determine that the first vehicle 101 and the second vehicle 102, which are clearly visible in the aerial view, may be partially occluded by the traffic circle 124 from the perspective of the third vehicle 103. As a result, these vehicles may be represented differently in the ground vehicle view generated for the third vehicle 103.

The processor 42 may evaluate relations among the ground vehicles and road objects in a sequence of aerial images captured by the aerial camera 30. This evaluation may involve analyzing the relative positions, velocities, and accelerations of the vehicles and objects over time.

In some cases, the processor 42 may incorporate these relations in the sequences of ground vehicle views generated for each vehicle. For the third vehicle 103, this may involve representing the movement patterns of the first vehicle 101 and the second vehicle 102 as they navigate around the traffic circle 124, even if these vehicles are partially occluded.

The processor 42 may determine that the fifth vehicle 105, the second pedestrian 125, and the second road obstacle 126 are within the third field of view 113 and not occluded by any buildings or other objects. These elements may be included in the ground vehicle view generated for the third vehicle 103, along with their respective information.

By analyzing the aerial data and considering both occlusions and relations from the ground-level perspective, the AI training system 20 may generate more accurate and realistic ground vehicle views for each vehicle. This approach may enhance the quality of the training data used for autonomous driving models, potentially improving their ability to predict and respond to the movements of other road users in complex traffic scenarios.

Referring now to FIG. 5, a method 200 for learning from air for autonomous driving is illustrated. The method may begin at step 202, where an aerial image containing aerial data of a region containing multiple ground vehicles and road objects is obtained. Typically, a sequence of many aerial images is obtained, showing changes over time in the locations and orientations of ground vehicles and moving ground objects. In some cases, obtaining the aerial image may comprise acquiring at least two aerial images from multiple different aerial locations.

Next, in step 204, the aerial data may be analyzed from respective points of view of multiple ground vehicles that appear in the aerial images. This analysis may involve a machine learning process. In this process, sequences of aerial images are associated with corresponding sequences of ground vehicle views in ego images captured by ground vehicles at known locations in the aerial images. These sequences are used to train a machine learning model, which can then be applied to subsequent aerial images in order to generate simulated ground vehicle views from the respective points of view of the ground vehicles that appear in the aerial images. For example, a neural network may be trained using the aerial image together with the ego images to transform the aerial image into the respective ground vehicle views corresponding to the ego images.

In some cases, the analysis may include constructing a three-dimensional (3D) model of the region based on the aerial image. The construction of the 3D model may involve applying topographical data with respect to the region in generating the 3D model. In cases where at least two aerial images are acquired from different locations, constructing the 3D model may comprise applying a stereoscopic transformation to the aerial images to generate the 3D model. The method may then involve projecting the respective points of view of the ground vehicles onto the 3D model.

Following the analysis, in step 206, respective ground vehicle views may be produced based on the analyzing. Each ground vehicle view may be from a respective point of view of a different ground vehicle and may include road object information pertaining to the respective point of view of each different ground vehicle.

In some cases, producing the respective ground vehicle views may comprise creating respective object list views from the respective points of view of the multiple ground vehicles. The trained neural network may be applied, for example, in transforming a subsequent set of the aerial images to produce further ground vehicle views. This approach may allow for efficient generation of ground vehicle views from new aerial imagery once the neural network has been trained.

The ground vehicle views may be applied in in training an artificial intelligence (AI) model to be used in driving an autonomous vehicle. In some cases, this may involve creating respective training sets for artificial intelligence models used in autonomous driving. The method may further comprise training the artificial intelligence models using these training sets. By leveraging aerial imagery to generate diverse ground-level perspectives, this method may provide a more efficient and scalable approach to creating training data for autonomous driving systems. The ability to produce multiple viewpoints from a single aerial image or set of images may enhance the breadth and depth of scenarios available for AI model training, potentially leading to more robust and adaptable autonomous driving capabilities.

In FIG. 5, the method 200 may include additional steps related to learning and incorporating ground noise distribution. After step 204 of analyzing the aerial data, the method may involve a process of learning ground noise distribution. This learning process may involve analyzing historical sensor data from ground vehicles to identify patterns of background noise typically present in various driving environments. The system may use statistical methods, such as Gaussian mixture models or kernel density estimation, to characterize the distribution of this ground noise. In some cases, the learning process may take into account different environmental factors such as weather conditions, time of day, or urban versus rural settings, which may affect the characteristics of ground-level noise.

These various factors may be applied in training a conversion model, built from the object lists, which learns the noise distribution from the aerial data, to convert the aerial data to ground vehicle data. The conversion can implement a direct conversion, such as a regression model that is trained to output the ground vehicle perspective directly. Alternatively or additionally, the conversion model can learn to model aerial distributions, for example by using a distribution model for sampling the data later on during the data generation phase.

Once the ground noise distribution is learned, it may be incorporated into the production of ground vehicle views in step 206. When creating object list views from the respective points of view of the multiple ground vehicles, the system may apply the learned ground noise distribution to each object in the list. This application may involve adjusting the perceived characteristics of objects based on the expected noise contribution. For example, the system may subtract the expected noise from each object's signal, potentially improving object detection accuracy and reducing false positives.

In some cases, the application of ground noise distribution may also involve adding simulated noise to the ground vehicle views to more accurately represent what a vehicle's sensors might detect in real-world conditions. The incorporation of learned ground noise distribution may enhance the realism and accuracy of the generated ground vehicle views, potentially improving the quality of training data for autonomous driving systems. This process may help account for sensor limitations and environmental factors that affect object detection and classification in real-world driving scenarios.

The training information generated through this process may be provided at different granularities. For example, the training information may be vehicle manufacturer specific, vehicle instance specific, vehicle year of manufacturing specific, or vehicle type specific.

By leveraging aerial imagery to generate diverse ground-level perspectives, this method may provide a more efficient and scalable approach to creating training data for autonomous driving systems. The ability to produce multiple viewpoints from a single aerial image or set of images may enhance the breadth and depth of scenarios available for AI model training, potentially leading to more robust and adaptable autonomous driving capabilities.

In some cases, the method may also involve applying the ground vehicle views in validating operations of an artificial intelligence model that has been trained using, at least in part, sensed data captured from a ground vehicle sensor for autonomous driving. This validation process may help ensure the reliability and accuracy of AI models used in autonomous driving systems.

The validation methodology may involve comparing the predictions of the AI model based on the generated ground vehicle views with the actual sensed data from ground vehicle sensors. This comparison may allow for assessment of the model's performance in various scenarios and conditions.

In some aspects, the validation process may begin with the collection and preparation of ground vehicle view data. This may involve selecting a set of ground vehicle views that represent a wide range of driving scenarios, environmental conditions, and object configurations. The ground vehicle views may be organized and labeled to facilitate efficient comparison with sensed data.

The system may employ techniques for aligning the generated ground vehicle views with the corresponding sensor data from ground vehicles. This alignment process may involve temporal and spatial synchronization to ensure accurate comparison. In some cases, the system may use GPS data, timestamps, and other metadata to match the generated ground vehicle views with the appropriate sensor readings.

Various metrics may be used to quantify the accuracy of AI model predictions against the ground truth provided by the sensor data. These metrics may include object detection accuracy, classification precision, distance estimation errors, and prediction consistency across multiple frames. The system may calculate these metrics for each scenario and aggregate them to provide an overall performance assessment of the AI model.

In some implementations, the validation process may involve analyzing discrepancies between AI predictions based on ground vehicle views and the actual sensor data. This analysis may help identify specific scenarios or conditions where the model's performance may need improvement. For example, the system may detect patterns in misclassifications or inaccurate distance estimations under certain lighting conditions or in complex traffic situations.

The results of this validation process may be used to refine and improve the AI model. In some cases, the system may automatically adjust model parameters or retrain specific components based on the identified discrepancies. This iterative process of validation and refinement may help enhance the overall performance and reliability of the autonomous driving system.

By incorporating this comprehensive validation process, the method may provide a robust framework for ensuring the accuracy and reliability of AI models used in autonomous driving applications. This approach may help identify and address potential limitations or biases in the model's performance, ultimately contributing to safer and more efficient autonomous driving systems.

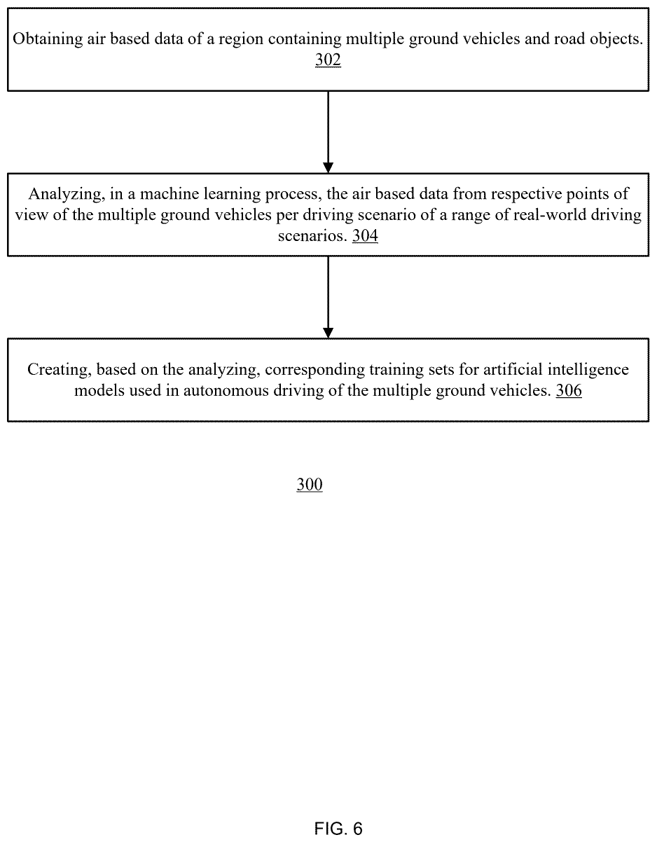

FIG. 6 is an example for method 300 that is computer-implemented and of learning from air of scenario-based artificial intelligence models for autonomous driving.

The introduction of scenario-based artificial intelligence models allows to add new models when new scenarios are detected and/or verified and also allows to separately train and retrain models that are scenario specific, e.g. to a driving scenario.

Dynamically adding new scenario-based artificial intelligence models is much simpler and much more effective, e.g. cost-wise, compute processing wise, than generating a vast artificial intelligence model that has to manage all known scenarios.

The current solution may involve performing gradual and/or incremental software updates (for example in a granularity of a scenario) to vehicle that are relatively compact and/or easy to test and/or are more robust than using a single vast machine learning process.

A driving scenario may include, or pertain to at least one of, for example, a location of the vehicle; weather conditions; contextual metrics and parameters; a road condition; a traffic parameter; and other. Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

Method 300 includes step 302 of obtaining air based data of a region containing multiple ground vehicles and road objects. The obtaining may include executing step 202—or performing another obtaining step.

According to an embodiment, step 302 is followed by step 304 of analyzing, in a machine learning process, the air based data from respective points of view of the multiple ground vehicles per driving scenario of a range of real-world driving scenarios.

According to an embodiment, step 304 is followed by step 306 of creating, based on the analyzing, corresponding training sets for artificial intelligence models used in autonomous driving of the multiple ground vehicles, wherein the corresponding training sets are created per driving scenario and include road object information pertaining to the respective point of view of the multiple ground vehicles in the driving scenario.

Road object information may include, relate or pertain to any type of descriptive information of one or more road objects captured in the air based data—for example—an object list, sensed information associated with the one or more road objects, processed sensed information, kinematic information regarding the one or more road objects, a simulated sensed information, an artificial intelligence generated (using for example regenerative artificial intelligence) sensed information (for example an artificial intelligence generated image) of the one or more road objects, filtered sensed information, segmentation and/or pixel information regarding the one or more road objects, one or more embeddings representing the one or more road objects, one or more signatures of the one or more road objects, and the like.

According to an embodiment, the respective training sets includes respective object list views from the respective points of view of the multiple ground vehicles for each driving scenario.

A single air based data may be shared by more than a single scenario—and thus there may be a partial overlap between training sets allocated to different scenarios.

According to an embodiment, the analyzing includes clustering and/or grouping and/or fusing and/or otherwise processing the air based data from respective points of view of the multiple ground vehicles per driving scenario.

Using such information typically increases the amount of information per driving scenario and may also be used for validating the gathered information and/or rejecting outliers from the cluster or group, and the like.

According to an embodiment, the analyzing includes clustering and/or grouping and/or fusing and/or otherwise processing the road object information from respective points of view of the multiple ground vehicles per driving scenario. Using such information increased the amount of information per scenario and may also be used for validating the gathered information and/or rejecting outliers from the cluster or group, and the like

According to an embodiment, the analyzing includes evaluating, for a driving scenario, kinematic relations among the multiple ground vehicles and between the ground vehicles and the road objects in a sequence of air based data; and incorporating the kinematic relations in a corresponding training set for an artificial intelligence model associated with the driving scenario.

According to an embodiment, the kinematic relations relate to movement patterns among the multiple ground vehicles and between the multiple ground vehicles and the road objects.

According to an embodiment, the evaluating of the relations includes analyzing relative positions, velocities, and accelerations of the multiple ground vehicles and the road objects over time.

According to an embodiment, the kinematic relationships is indicative of behaviors of the road objects and can be used to prevent collisions, path planning and the like.

Including behavior patterns of road users in the training set may have the following benefits:
a. Improved prediction accuracy—as each scenario-based artificial intelligence model can better anticipate the actions per scenario associated with it—and associated with the of pedestrians, cyclists, and drivers by learning from real-world behavior patterns.
b. Enhanced decision-making—as the scenario-based artificial intelligence models can make more informed and context-aware decisions. For example, recognizing when a driver is likely to yield, or when a pedestrian is hesitating, improves real-time judgment.
c. Greater safety-understanding typical and atypical behaviors helps the scenario-based artificial intelligence models to identify and respond to potential hazards more effectively, reducing collisions and improving safety for all road users.
d. Increased robustness in diverse environments-behavior patterns vary widely across scenarios. Including this variability in training data for scenario-based artificial intelligence models allows the scenario-based artificial intelligence models to operate safely and effectively in different scenarios.
e. Realistic simulation and testing-behavior-rich data enhances the realism of simulations used for training and testing scenario-based artificial intelligence models, allowing for better preparation for rare or complex scenarios.
f. Better interaction with human drivers-scenario-based artificial intelligence models trained on human behavior can more naturally integrate with human-driven traffic, such as merging, negotiating intersections, or handling four-way stops.

According to an embodiment the method also includes training the artificial intelligence models each per different driving scenario using the training set created for the different driving scenario. This will provide artificial intelligence models that are tailored to respond to different riad scenarios. Such artificial intelligence models may be arranged in assemblies that are arranged to cope with different road scenarios—as illustrated, for example, in U.S. patent application Ser. No. 17/823,069 which is incorporated herein by reference.

The method may also include generating, based on the analyzing, ground vehicle view data from the air based data and representing a given driving scenario; and applying the ground vehicle view data in validating operations of another artificial intelligence model trained for the given driving scenario using, at least in part, sensed data captured from a ground vehicle sensor for autonomous driving.

According to an embodiment, the results of this validation process may be used to refine and improve the AI model. In some cases, the system may automatically adjust model parameters or retrain specific components based on the identified discrepancies. This iterative process of validation and refinement may help enhance the overall performance and reliability of the autonomous driving system. By incorporating this comprehensive validation process, the method may provide a robust framework for ensuring the accuracy and reliability of AI models used in autonomous driving applications. This approach may help identify and address potential limitations or biases in the model's performance, ultimately contributing to safer and more efficient autonomous driving systems.

The following examples pertain to further embodiments.

Example 1 is a method of learning from air for autonomous driving. The method includes obtaining an aerial image containing aerial data of a region with multiple ground vehicles and road objects. It involves analyzing the aerial data from the perspectives of the multiple ground vehicles using a machine learning process. Based on this analysis, the method produces respective ground vehicle views, each from a different ground vehicle's point of view, including road object information relevant to that vehicle's perspective. These ground vehicle views are applied in training an artificial intelligence (AI) model to be used in driving an autonomous vehicle.

In Example 2, the method of Example 1 further specifies that producing the respective ground vehicle views involves creating respective object list views from the perspectives of the multiple ground vehicles.

Example 3 builds on Example 2, adding that producing the respective ground vehicle views includes incorporating respective learned ground noise distribution to objects of the object list views.

In Example 4, the method of Example 1 is further defined, where producing the respective ground vehicle views comprises creating respective training sets for artificial intelligence models used in autonomous driving.

Example 5 extends Example 4 by including the step of training the artificial intelligence models using the created training sets.

In Example 6, the method of Example 1 is elaborated, specifying that producing the respective ground vehicle views involves constructing a three-dimensional (3D) model of the region based on the aerial image, and projecting the respective points of view onto this model.

Example 7 builds on Example 6, where constructing the 3D model includes applying topographical data related to the region in generating the 3D model.

In Example 8, which extends Example 6, obtaining the aerial image involves acquiring at least two aerial images from different aerial locations. The 3D model construction then applies a stereoscopic transformation to these aerial images to generate the 3D model.

Example 9 expands on the method of Example 1, detailing that analyzing the aerial data includes capturing ego images from some of the multiple ground vehicles. It involves training a neural network using the aerial image and ego images to transform the aerial image into respective ground vehicle views corresponding to the ego images. The trained neural network is then applied to transform subsequent sets of aerial images to produce further ground vehicle views.

In Example 10, the method of Example 1 is further defined, where producing the respective ground vehicle views includes determining if a given object is occluded by another object from a specific ground vehicle's perspective. If occluded, the given object is excluded from that vehicle's ground vehicle view.

Example 11 elaborates on Example 1, specifying that analyzing the aerial data involves evaluating relationships among the multiple ground vehicles and between the vehicles and road objects in a sequence of aerial images. These relationships are then incorporated into the respective sequences of ground vehicle views during production.

In Example 12, the method of Example 1 is extended to include applying the ground vehicle views to validate operations of an artificial intelligence model. This model is trained using, at least partially, sensed data captured from a ground vehicle sensor for autonomous driving.

Example 13 describes a system for learning from air for autonomous driving. The system includes a memory for storing aerial images containing aerial data of a region with multiple ground vehicles and road objects. It also has a processor configured to analyze this aerial data from the perspectives of the multiple ground vehicles using a machine learning process. Based on this analysis, the processor produces respective ground vehicle views, each from a different ground vehicle's point of view, including relevant road object information. These views are intended for use in training an artificial intelligence (AI) model to be used in driving an autonomous vehicle.

Example 14 is a computer software product comprising a non-transitory computer-readable medium storing instructions. When executed by a processor, these instructions cause the processor to obtain an aerial image containing data of a region with multiple ground vehicles and road objects. The processor then analyzes this data from the perspectives of the multiple ground vehicles using a machine learning process. Based on this analysis, it produces ground vehicle views from each vehicle's point of view, including relevant road object information, for use in autonomous driving.

Machine readable storage including machine-readable instructions, when executed, to implement a method or realize an apparatus in any of the examples of the present application.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. A computer-implemented method of learning from air of scenario-based artificial intelligence models for autonomous driving, the method comprising:
obtaining air based data of a region containing multiple ground vehicles and road objects;
analyzing, in a machine learning process, the air based data from respective points of view of the multiple ground vehicles per driving scenario of a range of real-world driving scenarios; and
creating, based on the analyzing, corresponding training sets for artificial intelligence models used in autonomous driving of the multiple ground vehicles, wherein the corresponding training sets are created per driving scenario and include road object information pertaining to the respective point of view of the multiple ground vehicles in the driving scenario.

2. The computer-implemented method according to claim 1, wherein analyzing comprises clustering the air based data from respective points of view of the multiple ground vehicles per driving scenario.

3. The computer-implemented method according to claim 1, wherein analyzing comprises clustering the road object information from respective points of view of the multiple ground vehicles per driving scenario.

4. The computer-implemented method according to claim 1, wherein the road object information is of an image.

5. The computer-implemented method according to claim 1, wherein analyzing the air based data comprises evaluating, for a driving scenario, kinematic relations among the multiple ground vehicles and between the ground vehicles and the road objects in a sequence of air based data; and incorporating the kinematic relations in a corresponding training set for an artificial intelligence model associated with the driving scenario.

6. The computer-implemented method according to claim 1, further comprising training the artificial intelligence models each per different driving scenario using the training set created for the different driving scenario.

7. The computer-implemented method according to claim 1, wherein the kinematic relations relate to movement patterns among the multiple ground vehicles and between the multiple ground vehicles and the road objects.

8. The computer-implemented method according to claim 5, wherein evaluating the relations comprises analyzing relative positions, velocities, and accelerations of the multiple ground vehicles and the road objects over time.

9. The computer-implemented method according to claim 1, wherein creating the respective training sets comprises creating respective object list views from the respective points of view of the multiple ground vehicles for each driving scenario.

10. The computer-implemented method according to claim 1, further comprising:
generating, based on the analyzing, ground vehicle view data from the air based data and representing a given driving scenario; and
applying the ground vehicle view data in validating operations of another artificial intelligence model trained for the given driving scenario using, at least in part, sensed data captured from a ground vehicle sensor for autonomous driving.

11. A computer-readable medium storing instructions that, when executable by at least one processing device, cause the device to:
obtain air based data of a region containing multiple ground vehicles and road objects;
analyze, in a machine learning process, the air based data from respective points of view of the multiple ground vehicles per driving scenario of a range of real-world driving scenarios; and
create, based on the analyzing, corresponding training sets for artificial intelligence models used in autonomous driving of the multiple ground vehicles, wherein the corresponding training sets are created per driving scenario and include road object information pertaining to the respective point of view of the multiple ground vehicles in the driving scenario.

12. The computer readable medium according to claim 11, wherein the processing device analyzes the air based data by clustering the air based data from respective points of view of the multiple ground vehicles per driving scenario.

13. The computer readable medium according to claim 11, wherein analyzing comprises clustering the road object information from respective points of view of the multiple ground vehicles per driving scenario.

14. The computer readable medium according to claim 11, wherein the road object information is of an image.

15. The computer-readable medium according to claim 11, wherein the processing device analyzes the air based data by evaluating, for a driving scenario, kinematic relations among the multiple ground vehicles and between the ground vehicles and the road objects in a sequence of aerial images; and incorporating the kinematic relations in the training set for the driving scenario.

16. The computer-readable medium according to claim 11, wherein the stored instructions further cause the processing device to train the artificial intelligence models each per different driving scenario using a corresponding training set created for the driving scenario.

17. The computer-readable medium according to claim 11, wherein the kinematic relations relate to movement patterns among the multiple ground vehicles and between the multiple ground vehicles and the road objects.

18. The computer-readable medium according to claim 15, wherein the processing device evaluates the relations by analyzing relative positions, velocities, and accelerations of the multiple ground vehicles and the road objects over time.

19. The computer-readable medium according to claim 11, wherein the processing device creates the corresponding training sets by creating respective object list views from the respective points of view of the multiple ground vehicles for each driving scenario.

20. The computer-readable medium according to claim 11, wherein the stored instructions further cause the processing device to:
generate, based on the analyzing, ground vehicle view data from the air based data and representing a given driving scenario; and
apply the ground vehicle view data in validating operations of another artificial intelligence model trained for the given driving scenario using, at least in part, sensed data captured from a ground vehicle sensor for autonomous driving.
